(19) United States
(12) Patent Application Publication
(10) Pub. No.: US 2015/0026890 A1
(43) Pub. Date: Jan. 29, 2015

(54) EMERGENCY POWER SUPPLY DEVICE FOR AN ELECTROMOTIVE FURNITURE DRIVE FOR A PIECE OF FURNITURE, ELECTROMOTIVE FURNITURE DRIVE, AND A CORRESPONDING PIECE OF FURNITURE

(71) Applicant: DEWERTOKIN GMBH, Kirchlengern (DE)

(72) Inventors: Armin Hille, Bielefeld (DE); Thomas Schröder, Kirchlengern (DE)

(21) Appl. No.: 14/381,899

(22) PCT Filed: Feb. 28, 2013
(86) PCT No.: PCT/EP2013/054091

§ 371 Date: Aug. 28, 2014

(30) Foreign Application Priority Data
Feb. 28, 2012 (DE) 10 2012 101 624.0

(51) Int. Cl. A61G 7/018; A47C 7/50; A61G 7/015; A47C 1/024; H02J 1/00; H02P 4/00

(52) U.S. Cl. CPC A61G 7/018; H02J 1/00; H02P 4/00; A61G 7/015; A47C 1/0242; A47C 7/506
USPC 5/613; 307/43; 318/139; 297/68

(57) ABSTRACT

The invention relates to an emergency power supply device (200) for an electromotive furniture drive (100) of a piece of furniture (1), comprising a housing in which at least one energy accumulator is arranged, a connection cable having at least two power lines and several auxiliary lines for connecting to the electromotive furniture drive which is to be associated therewith, a socket for connecting a control unit of the electromotive furniture drive which is to be associated therewith, at least one control element which, when actuated, electrically connects the electric connections of the at least one energy accumulator to the at least two power lines of the connection cable. The housing is designed as a shell housing comprising securing sections and an inner compartment for receiving the at least one energy accumulator, said at least one control element and at least one night light. The invention also relates to an electromotive furniture drive (100) and a piece of furniture (1).

The invention relates to an emergency power supply device for an electromotive furniture drive for a piece of furniture according to the preamble of Claim 1. The invention also relates to an electromotive furniture drive. In addition, the invention relates to a corresponding piece of furniture.

Emergency power supply devices for electromotive furniture drives are known and have batteries and/or accumulator cells as energy stores. An emergency power supply device is predominantly used for an emergency lowering function of the electromotive furniture drive in the event of network failure or in the event of failure of the remote-control battery.

An emergency power supply in the form of a battery in a handheld switch for adjusting a piece of furniture is described in DE 88 04 417 U1, wherein upon actuation of a button, the electrical energy of the battery is provided for moving the motors of the piece of furniture. The weight of the handheld switch is relatively high due to the battery and the amount of energy stored in the battery is small.

DE 298 21 395 U1 describes an emergency actuation switch unit, which also has batteries and in which the connection cable is arranged between the operating unit and the electromotive furniture drive. It is considered to be disadvantageous in this case that the high intrinsic weight of the emergency actuation switch unit requires an additional installation expenditure of cable guides, strain relief units, and longer connection cables.

The demand for auxiliary functions of electromotive furniture drives is currently growing. Furniture and electromotive furniture drives are mass-produced articles and are only produced in a specific configuration. Upgrading them is typically not possible or is linked to a large expenditure.

An electromotive furniture drive comprises at least one electric motor, which is frequently implemented as a brush-type DC motor. A gear is connected downstream from the motor, wherein a DC geared motor is typically used. Furthermore, the electromotive furniture drive comprises an operating unit and a control unit. The operating unit can be designed as wired or wireless and has a number of pushbuttons, upon the actuation of which a control signal for electrical activation of the respective motor in the respective rotational direction is produced via the signal transmission.

Pieces of furniture having multiple support surfaces for supporting a person located in the piece of furniture are widespread and well known as, for example, beds, sofas, armchairs, and the like. They have at least one movable support surface, which is movably mounted in relation to at least one further support surface. The movable support surface is, for example, a back part and/or a leg part, which is adjustable using at least one electromotive furniture drive. For this purpose, the movable support surface can be pivotable, displaceable, or both by means of a suitable fitting. It is also possible that a base element, for example, a bed frame, is embodied as vertically-adjustable using one or more furniture drives.

The object of the present invention is to provide an improved emergency power supply device.

A further object is to provide an improved electromotive drive.

Still a further object is to provide an improved piece of furniture.

The object is achieved by an emergency power supply device having the features of Claim 1.

The further object is achieved by an electromotive drive having the features of Claim 14.

The still further object is achieved by a piece of furniture having the features of Claim 15.

An emergency power supply device is provided, which forms a compact module having a nightlight and a button actuation.

The deficiencies of the prior art are compensated for.

An emergency power supply device according to the invention for an electromotive furniture drive of a piece of furniture comprises a housing, in which at least one energy store is arranged, a connection cable having at least two power lines and at least one auxiliary line for connection to the electromotive furniture drive to be associated, a bushing for connecting an operating unit of the electromotive furniture drive to be associated, and at least one operating element. The housing is implemented as an envelope housing having fastening sections and having an internal compartment for accommodating the at least one energy store and the at least one operating element.

It is particularly advantageous in this case that the emergency power supply device is simply and rapidly fastenable to the housing in a simple manner using the fastening sections. The fastening sections are provided for advantageous easy, simple, and essentially universal installation.

In one embodiment, the housing is a profile which is cut to length, one transverse side of which is closed using a transverse wall like a plug. A more modular construction may thus be achieved, which additionally can be easily sealed and is easy to integrate in a piece of furniture.

In a further embodiment, at least one nightlight is arranged in the housing. It is particularly advantageous in this case that with the aid of the nightlight, not only is the at least one operating element also reliably reachable in the dark, but rather also an underside of the piece of furniture to be associated, for example, a bed, can also be illuminated.

In a further embodiment, it is provided that a movement detector or proximity switch, which controls the nightlight, is associated with the at least one nightlight. Therefore, by merely approaching the emergency power supply device, the nightlight is advantageously automatically turned on and finding the actuating element is made substantially easier.

The power supply device according to the invention additionally fulfills auxiliary functions, which the furniture drive to be associated or the piece of furniture to be associated do not have.

It is thus provided in a further embodiment that the emergency power supply device furthermore has a charging unit for the at least one energy store. In this case, the energy store is rechargeable as an accumulator cell and is practically maintenance-free. Frequent replacement of batteries is dispensed with. Operational readiness of the emergency power supply device is advantageously lengthened.

In still a further embodiment, the emergency power supply device furthermore has an operating element, which is implemented as an electrical button for training operating units having control of a wireless transmission link (radio/infrared/ultrasound). This is an advantageous auxiliary function.

In another embodiment, the emergency power supply device furthermore has an operating element as an auxiliary button, which is implemented as an electrical button for the activation of synchronization of devices to be associated. An advantageous auxiliary function is also provided in this way.

In still another embodiment, it is provided that the emergency power supply device furthermore has a keyboard having keyboard elements, which are provided as operating elements for moving adjustment drives of the electromotive furniture drive to be associated. Therefore, in the case of an operating unit which has failed, emergency operation of the electromotive furniture drive to be associated can nonetheless be ensured, even if a network failure does not exist.

A further embodiment provides that the emergency power supply device furthermore has a USB terminal. This is an advantageous auxiliary function, which can be used, for example, for a data exchange with a service device connectable to the USB terminal. It is particularly advantageous in this case if the emergency power supply device furthermore has at least one storage unit for storing drive-related data.

For a further auxiliary function, the emergency power supply device is furthermore equipped with a Bluetooth unit, which offers particular advantages in the wireless data exchange, for example.

For this purpose, the Bluetooth unit can be a Bluetooth converter and/or a WLAN converter, and can be provided for activating the electromotive furniture drive to be associated and/or for a wireless data exchange.

In still a further embodiment, the auxiliary lines of the connection cable are control lines and signal lines, data lines, and/or auxiliary energy lines. Therefore, not only is an emergency power supply of the furniture drive to be associated ensured, but rather also an advantageous auxiliary function for service is provided.

An electromotive furniture drive for adjusting a movable part of a piece of furniture by means of an output element comprises a) at least one adjustment drive having in each case at least one electric motor, a speed-reducing gear coupled thereto, to which the output element is coupled in drive technology and is movable so it is linearly movable and/or rotatable, b) at least one control unit, and c) at least one operating unit. The electromotive furniture drive has the above-described emergency power supply device.

A piece of furniture, a) having at least one base element for coupling of the piece of furniture to a setup location, and b) having at least one support element, which has at least one part arranged so it is movable in relation to the support element or in relation to a further support element or in relation to the base element, c) wherein the at least one movably arranged part (4, 5) is implemented as displaceable and/or pivotable, d) wherein the piece of furniture has at least one electromechanical furniture drive, e) wherein the at least one movably arranged part is coupled to the at least one electromechanical furniture drive, has the above-described electromotive furniture drive having the power supply device.

In one embodiment, it is provided that the control unit of the electromotive furniture drive of the piece of furniture has a charging circuit for the at least one energy store of the emergency power supply device. Usage readiness of the emergency power supply device may thus be increased.

The emergency power supply device according to the invention is therefore provided as a compact universal “module”. It offers the following advantages, inter alia:
Plastic housing having internal energy store.
It can also be attached subsequently to any piece of furniture/any furniture drive.
It has at least one electrical terminal for connection to the piece of furniture/to the furniture drive.
The at least one electrical terminal has at least two power lines for transmitting power energy to power the piece of furniture/the furniture drive/auxiliary consumers (lamps, massage units, lights, control devices, control signal receivers, or the like).
The at least one electrical terminal furthermore has auxiliary lines for different purposes and auxiliary functions.
In a minimal embodiment, the components of energy store and electrical button are connected to three cores of the terminal for connection to the piece of furniture/to the furniture drive, wherein two cores conduct the power of the energy store and the at least one third core is connected to a switch contact of the electrical switch.

The invention will be explained in greater detail on the basis of the appended drawings. In the figures:

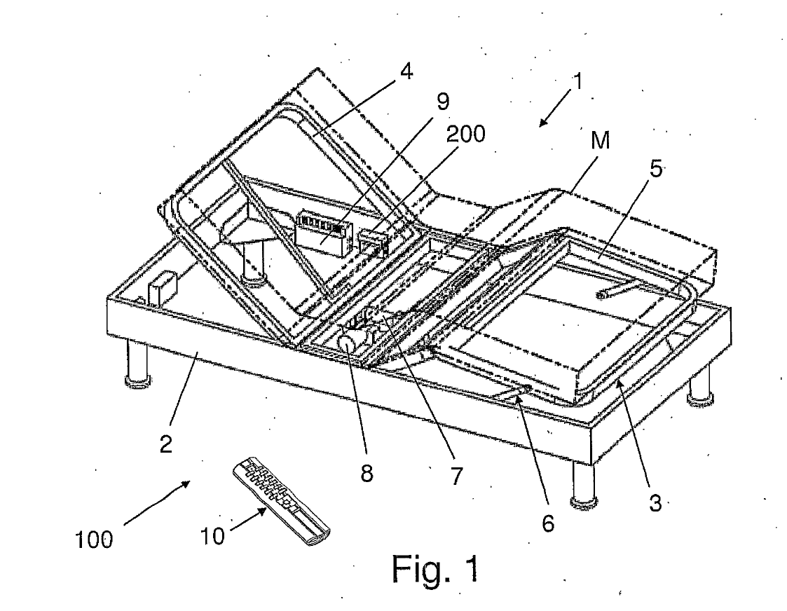

FIG. 1 shows a schematic perspective view of an exemplary piece of furniture according to the invention;

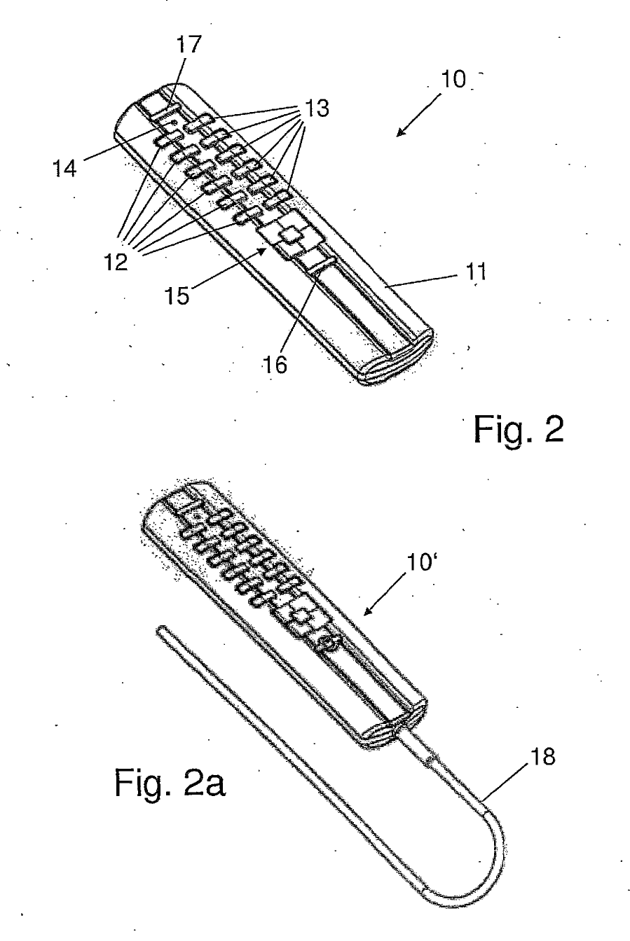

FIGS. 2-2a show schematic perspective views of an operating unit;

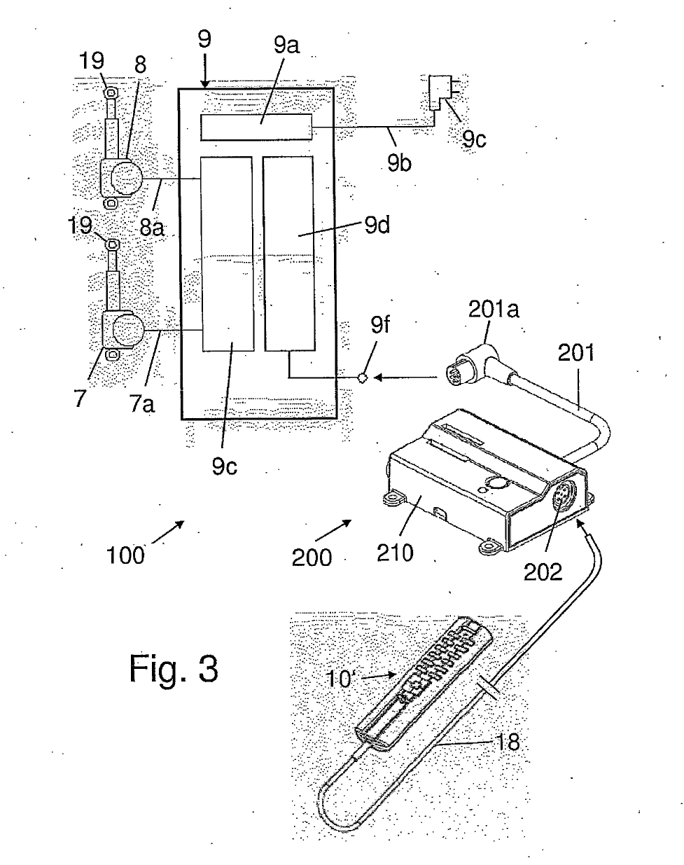

FIG. 3 shows a schematic block diagram of an exemplary embodiment of an electromotive furniture drive according to the invention;

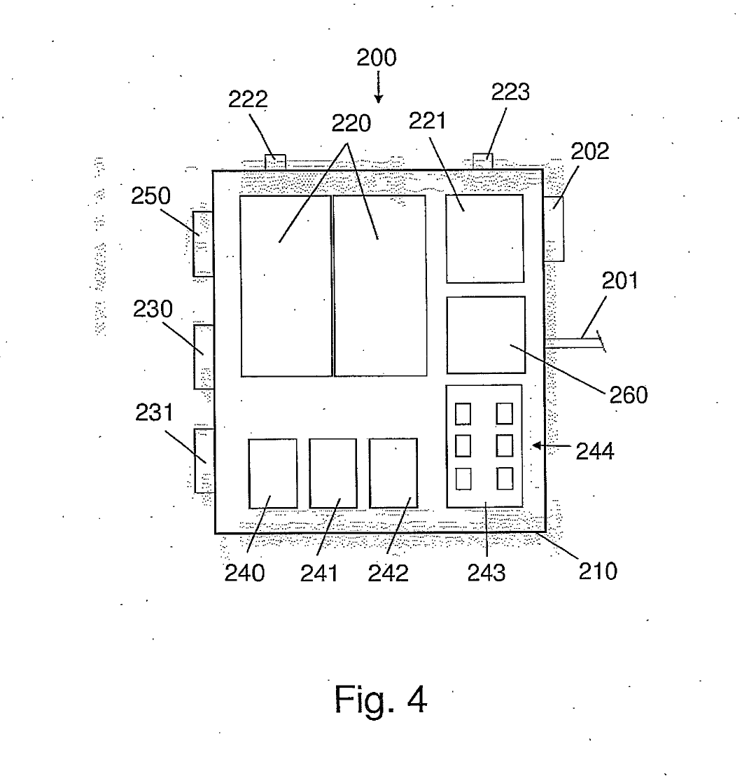

FIG. 4 shows a schematic block diagram of an exemplary embodiment of an emergency power supply device according to the invention; and

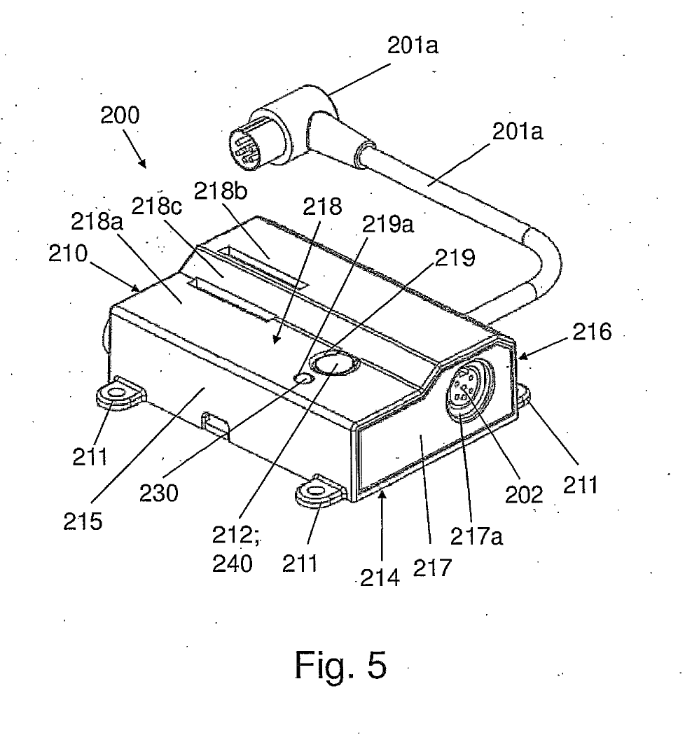

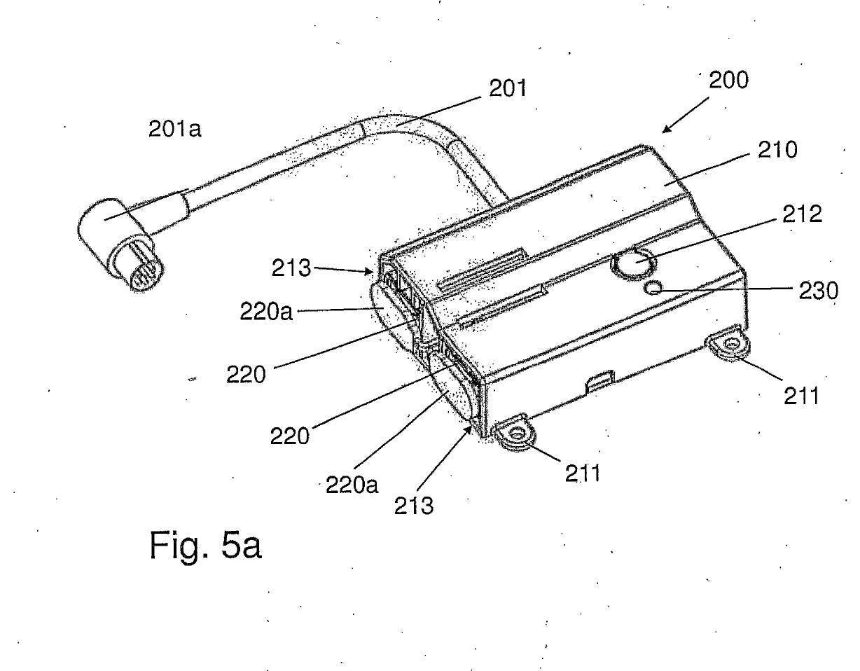

FIGS. 5-5a show schematic perspective views of the exemplary embodiment of the emergency power supply device according to the invention from FIG. 4.

FIG. 1 shows an exemplary embodiment of a piece of furniture 1 according to the invention. In FIGS. 2 and 2a, schematic perspective views of an operating unit 10, 10′ are shown. FIG. 3 shows a schematic block diagram of an exemplary embodiment of an electromotive furniture drive 100 according to the invention.

The piece of furniture 1 is shown here as a bed and has at least one support element 3 for accommodating objects, upholstery, a mattress M, and/or a person. The support element 2 is implemented, for example, as a slatted frame, as a level support surface, or the like, and is attached to a base element 2, a framework having feet here, for coupling of the piece of furniture 1 to a setup location, for example, a floor.

The support element 3 has here a back part 4 and a leg part 5, which are arranged mounted movably in relation to the support element 3 and/or a further support element or in relation to the base element 2. This movable arrangement is implemented here by means of a so-called movement fitting 6. The movement is implemented as displaceable and/or pivotable.

The piece of furniture 1 additionally has an electromotive furniture drive 100, which comprises here two adjustment drives 7 and 8, a control unit 9, and an operating unit 10.

The movably mounted back part 4 and the leg part 5 are each coupled to one adjustment drive 7, 8. The back part 4 is thus coupled to the adjustment drive 7. The adjustment drive 8 is provided for the movement or adjustment of the leg part 5.

The adjustment drives 7, 8 are implemented here as linear drives. The linear drives have one or a number of electric motors, wherein a speed-reducing gear having at least one gear step is connected downstream from each motor. A further gear, for example, in the form of a threaded spindle gear, which generates a linear movement of an output element 19 from the rotational movement of the motor (FIG. 3), can be connected downstream from the speed-reducing gear. The last gear element or a further element connected thereto forms the output element 19. The output element 19 of the respective adjustment drive is connected to the respective furniture component (back part 4, leg part 5) or alternatively to a component connected to the base frame 2, so that during an operation of the electric motor of the respective adjustment drive 7, 8, the movable furniture components 4, 5 are adjusted in relation to one another or in relation to the base frame 2.

The adjustment drives 7, 8 are each connected to a control unit 9 via a drive line 7a, 8a, as shown in FIG. 3. The drive lines 7a, 8a can be embodied as pluggable cable connections, for example. The control unit 9 has an electrical power supply unit 9a, which provides the electrical energy, for example, from the network, for the adjustment drives 7, 8. For this purpose, the control unit 9 is connectable in this example via a network cable 9b having a network plug 9c to a network terminal. The network plug 9c conducts, via the network cable 9b, the input-side network voltage to the electrical supply unit 9a of the control unit 9, which outputs a low voltage in the form of a DC voltage on the secondary side and relays it to a motor controller having a control block 9d and control switches 9e.

Alternatively thereto, a network-dependent voltage supply (not shown in greater detail) having network input and having secondary-side low voltage, which supplies the low voltage in the form of a DC voltage via the line 9d, is connected upstream from the control unit 9.

In addition, the electromotive furniture drive 100 comprises an emergency power supply device 200, which is attached in the exemplary embodiment shown in FIG. 1 to an inner side of the base element 2. The emergency power supply device 200 has a housing 210 (FIG. 3) and will be explained in greater detail hereafter.

Furthermore, an operating unit 10, 10′ is assigned to the piece of furniture 1, using the operating elements 12, 13 of which (see FIG. 2), the adjustment drives 7, 8 are controllable via the control unit 9.

The operating unit 10 in FIG. 1 is provided according to FIG. 2 with a transmitting unit or transceiver unit for wireless transmission. The wireless transmission can be a radio transmission link, optical transmission link (for example, infrared), and/or an ultrasound transmission link, wherein the control unit 9 is equipped with a respective corresponding receiving unit.

In another embodiment, which is shown in FIG. 2a and FIG. 3, the operating unit 10′ is implemented with an operating line 18 in wired form. In this case, the operating line 18 is connectable to the control unit 9, for example, pluggable. For this purpose, the free end of the operating line 18 is provided with a plug (not shown), which is typically inserted into a bushing of a control terminal 9f of the control unit 9 (FIG. 3).

In the exemplary embodiment of the electromotive furniture drive 100 shown in FIG. 3, the emergency power supply device 200 is arranged connected between the operating unit 10′ and the control unit 9. In this case, the operating line 18 of the operating unit 10 is connected to the emergency power supply device 200, in that the plug (not shown) is plugged into a bushing 202 corresponding thereto, which is indicated by a small arrow in FIG. 3. Instead of the operating unit 10′, a connection cable 201 having a plug 201a is now connected to the control terminal 9f of the control unit 9, which is also indicated by an arrow. In this case, the connection cable 201 has all cores of the operating line 18. However, in a preferred embodiment, the operating line 18 is connected in a pluggable manner to a terminal of the control unit 9.

The operating unit 10, 10′ is provided with operating elements 12, 13, which are provided for operating a respective adjustment drive 7, 8. The operating elements 12, 13 are embodied as buttons, for example. For example, the operating elements 12 are used for raising and the operating elements 13 are used for lowering the respective movable furniture part. FIGS. 2 and 2a show operating units 10, 10′ for six adjustment drives.

Furthermore, the operating unit 10, 10′ is equipped with a signal element 14, for example, a light-emitting diode. The signal element 14 is used, for example, for function display or feedback, error display, etc.

An auxiliary operating element 15, which can also consist of multiple operating elements and/or a combination operating element, is used for a so-called memory function of the adjustment drives 7, 8.

In addition, auxiliary functions, for example, reading lamp and/or heater, can be operable by means of further auxiliary operating elements 16, 17.

The auxiliary operating elements 15, 16, 17 can be embodied as buttons and/or switches.

Upon actuation of an operating element 12, 13, a control signal for activating the respective adjustment drive 7, 8 is transmitted wirelessly or in a wired manner to the control unit 9 via the transmission link. The control unit 9 has control switches 9e having switch elements, which, triggered from the control block 9d by the control signals of the transmission link, receive switching signals for switching the switch elements to move the respective adjustment drive 7, 8. The switching elements can be, for example, relay switches and/or semiconductor switches. The manually operable operating elements 12, 13 of the operating unit 10 generate control signals, which are converted in the case of a wireless transmission link by a receiver (not shown) of the control unit 9 into control currents for the control block 9d. In the case of the wired operating unit 10′, the operating elements 12, 13 switch the control current of the relay switches with the semiconductor switches. In both cases, the power switches of the relay switches or the semiconductor switches switch the high motor current of the respective adjustment drive 7, 8.

In the case of a wireless operating unit 10, which is shown in FIG. 1 and FIG. 2, the emergency power supply device 200 is connected to the control unit 9 as described above. The bushing 202 of the emergency power supply device 200 remains free of this case. The wireless operating unit 10 then communicates wirelessly with the receiver (not shown) of the control unit 9.

The adjustment drives 7, 8 can be implemented as brush-type DC motors or can comprise them.

FIG. 4 shows a schematic block diagram of an exemplary embodiment of the emergency power supply device 200 according to the invention.

The exemplary embodiment shown in FIG. 4 displays the scope of many options, with which the emergency power supply device 200 is equipped.

The emergency power supply device 200 is a compact, universal module. It has a housing 210, preferably made of plastic, in which at least one energy store 220 is arranged. The energy store 220 can be a battery and/or an accumulator cell, wherein the accumulator cell is preferably maintenance-free.

The emergency power supply device 200 comprises at least one connection cable 201 having the plug 201a and at least one bushing 202, in addition a charging unit 221 for the at least one energy store 220, signal lights 222 and 223, at least one nightlight 230, a movement detector 231 or proximity switch for the nightlight 230, operating elements 240, 241, and 242, a keyboard 243 having keyboard elements 244, a USB terminal 250, and a Bluetooth unit 260.

The connection cable 201 has two lines for transmitting power energy for the emergency power supply of the supply unit 9a of the control unit 9 and therefore for powering the electromotive furniture drive 100 and auxiliary consumers, for example, lamps, massage units, control devices, receivers, etc. These two lines are connectable by means of the operating element 240 to the at least one energy store 220. At least one safeguard element (not shown) is also provided for these two lines, which can be, for example, a safety fuse or a circuit breaker.

Alternatively, at least one of the switch contacts of the operating element 240 is connected to a core of the connection cable 201 and an electrical signal is applied to said core in the event of actuation, wherein the control unit 9 thus recognizes the actuation.

Furthermore, the connection cable 201 has auxiliary lines, which will be explained in greater detail hereafter. Some of the auxiliary lines, which relay the signals of the operating unit 10′ to be attached to the bushing 202 to the control unit 9, are always connected to the contacts of the bushing 202.

One possible connection configuration of auxiliary lines and power lines is described in document DE 298 21 395 U1, to which reference is made here.

The signal light 222 signals a charging status of the at least one energy store 220 and can be connected to the charging unit 221, which has a corresponding output for this purpose.

The signal light 223 signals, by lighting up, the presence of network voltage or operating voltage in the input of the supply unit 9a of the control unit.

The nightlight 230, which can also be referred to as an under bed light, is used to illuminate a specific region on the furniture 1 for the person who is using the furniture 1. The specific region can be, for example, the floor region on one bed side. The nightlight 230 can be turned on and off in various ways. A separate switch can be provided, for example, on the operating unit 10, 10′ and/or on the emergency power supply device 200. It can turn on automatically, for example, when the electromotive furniture drive 100 is actuated. It can also be turned on by the movement detector 231 and can be turned off after passage of a previously settable time.

The operating element 240 is a button. In one embodiment it connects the at least one energy store 220 to the two power lines of the connection cable 201 upon actuation. In another embodiment, it applies a signal to cores of the connection cable 201.

The operating element 241 is also implemented as a button, which is used for training operating units 10 having control of a wireless transmission length (radio/infrared/ultrasound).

A synchronization of various devices, which are not described in greater detail here, can be activated using the operating element 242, which is an auxiliary button.

According to another embodiment, the operating elements 240, 241, 242 are implemented as a single button and are each pressed using a button code to execute different commands, which can also be considered to be a command input. Furthermore, the nightlight 230 can also be implemented as the signal lights 222 and 223, which corresponds to an optical signal output.

The keyboard 243 having the keyboard elements 244 simulates the operating elements 12, 13 of the operating unit 10, 10′ and is used for moving the adjustment drives 7, 8 of the electromotive furniture drive 100 in an emergency operating state if, for example, the operating unit 10, 10′ should fail.

The USB terminal 250 is used for connecting various devices having USB connection. It can also have a charging capability for these devices. The USB terminal 250 can also be embodied as a mini USB, for example, an additional terminal.

Thus, for example, accumulator cells of mobile telephones can also be charged at the USB terminal 250. A data exchange is also possible if the USB terminal 250 is connected via auxiliary lines by the terminal cable 201 to the control unit 9. For example, a connection of a PC/laptop/service device is possible. In this case, the USB terminal 250 can be used as a data interface, which is daisy-chained through the emergency power supply device 200, for data transmission from and to the control unit 9. Alternatively, the emergency power supply device 200 can also have a storage unit for storing drive-related data. Thus, service data can be read out, and control programs and/or control commands can be changed.

The Bluetooth unit 260 can be, for example, a Bluetooth converter and/or a WLAN converter and/or a Zigbee converter and is used for activating the electromotive furniture drive 200 via Bluetooth and/or WLAN and/or Zigbee. A wireless data exchange can thus also be performed.

In a minimal configuration, the emergency power supply device 200 only has the following:

The housing 210 having the at least one energy store 220, the connection cable 201, the bushing 202, the operating element 240, and the nightlight 230.

The auxiliary lines of the connection cable 201 can be control lines and signal lines, data lines, and/or auxiliary energy lines. They extend between the control unit 9 of the electromotive furniture drive 100 and the emergency power supply device 200, and also to freely accessible plug terminals of the emergency power supply device 200.

The control lines and signal lines are used to control motors, lamps, or other components of the piece of furniture 1 and/or furniture drive 100, to control a so-called network cutoff switch, and to control auxiliary functions of the emergency power supply device 200, for example, turning on the nightlight 230.

The data lines are used to connect an external PC/laptop/service device to the electric motor furniture drive 100 or to the piece of furniture 1, and to connect the electromotive furniture drive 100 or the piece of furniture 1 to intranet/Internet/LAN.

The auxiliary energy lines are used for charging the at least one energy store 220 by way of a charging circuit (not shown) in the control unit 9, if no charging unit 221 is present in the emergency power supply device 200.

All electrical and electronic components of the emergency power supply device 200 can be directly wired or can partially be arranged on circuit boards. The circuit boards can also be flexible circuit boards. Of course, other embodiments and combinations are possible, for example, conductors embedded in the housing material.

FIGS. 5 and 5a show schematic perspective views of the exemplary embodiment of the emergency power supply device 200 according to the invention from FIG. 4.

The housing 210 of the emergency power supply device 200 is shaped as a type of envelope housing and has here a floor wall 214, longitudinal sides 215 and 216 of different heights, a transverse wall 217, and a cover wall 218 having two surfaces 218a and 218b, which are stepped to one another. The surface 218a extends along one longitudinal side wall 215, which is lower than the other longitudinal side wall 216. In the transverse direction, perpendicularly to the longitudinal side wall 215, the surface 218a extends approximately up to the middle, then merges into a connection surface 218c extending diagonally upward in a transverse direction (approximately at an angle 40-45°), which is connected to one longitudinal side of the other, taller surface 218b. The longitudinal side of the taller surface 218a, which faces toward the other longitudinal side wall 216, is also connected to the upper edge of the longitudinal side wall 216 via an inclined surface, which is inclined downward at an angle which approximately corresponds to the other angle.

The transverse side of the housing 210 opposite to the transverse wall 217 is open and forms an access to a compartment 213, which is divided here into two parts and accommodates the energy stores 220, two 9 V batteries or accumulators here. The energy stores 220 are each connected using terminal clips 220a (FIG. 5a) to a circuit board (not shown) in the interior of the housing 210,

The transverse wall 217 of the housing 210 is provided in the region of the taller section adjacent to the taller longitudinal side wall 216 with an opening 217a, through which the bushing 202 is reachable.

The terminal cable 201 is led out of the taller longitudinal side wall 216, wherein a typical cable screw connection having anti-buckling protection is used.

A fastening section 211 having a hole for fastening the emergency power supply device 200 in the form of a screw-on tab is molded onto each of the lower corners of the longitudinal side walls 215. Fastening, for example, using screws onto the piece of furniture 1 can thus be performed. Instead of the screw-on tabs, plug-in tabs and/or plug-in rails can also be provided as the fastening sections 211.

A springy actuating tab 212 is formed by means of a peripheral recess 219 in the lower surface 218a of the cover wall 218. Below this actuating tab 212, the operating element 240 is arranged, which can be actuated by the springy actuating tab 212 when external pressure is applied to the actuating tab 212. An opening 219 is introduced into the surface 218a in front of this, in which the nightlight 230, for example, LED, is arranged. The nightlight 230 is therefore arranged in direct proximity to the operating element 240 and the actuating tab 212, to ensure rapid finding thereof. For this purpose, the nightlight 230 can be automatically turned on by the movement detector 231 or proximity switch, wherein it is electrically powered by the at least one energy store 220 or a separate energy store.

The connection cable 201 is only shown as an example, wherein its length can also result differently from the illustrated length, of course.

On the function of the emergency power supply device 200:

The contacts of the bushing 202 are completely daisy-chained through the housing 210 and are further available at the contacts of the plug 201a of the connection cable 201. The at least one energy store 220 is completely electrically disconnected from the two power lines when not in use. Upon actuation of the operating element 240, an emergency power supply program is activated in the control unit 9, wherein the terminals of the at least one energy store 220 are connected to the two power lines.

The emergency power supply program of the control unit 9, which can be executed, for example, in the control block 9d (FIG. 3) by a microprocessor or microcomputer, ascertains, for example, using a voltage measurement, on the two power lines of the connection cable 201, that a voltage caused by the at least one energy store 220 is continuously applied and thus starts further sequences of the emergency power supply program.

Alternatively, the emergency power supply program of the control unit 9 ascertains, for example, using signal monitoring on at least one auxiliary line or control line of the connection cable 201, that a button press of the operating element 240 occurred and thus starts further sequences of the emergency power supply program.

The emergency power supply program preferably starts by a single or continuous press of the operating element 240, 241, 242. Other programs can be started by multiple coded presses of the operating element 240, 241, 242. Other programs can also be started by pressing one operating element 240 or 241 or 242. Another program includes, for example, the so-called pairing between a wireless operating unit 10, 10′ and a control unit, wherein the radio protocols or the radio frequencies for communication via the wireless transmission link equate themselves. A further other program executes the switching of a voltage output of the control unit 9 or the emergency power supply unit 200, wherein the voltage output has a low voltage for connecting electrical consumers, for example, lights. A voltage output of the control unit can have a network voltage.

Predetermined adjustment drives 7, 8 are then moved in a predetermined rotational direction, which causes the parts of the piece of furniture 1 connected thereto to be adjusted into a base position or into predetermined positions. If these positions have been reached, further required functions are maintained by means of the emergency power supply program, for example, messages, warnings, and alarms.

The invention is not restricted to the above-described exemplary embodiments. It is modifiable in the scope of the appended claims.

Thus, it is conceivable, for example, that the emergency power supply device 200 has further auxiliary terminals, for example, for devices having hollow plugs or the like.

A further emergency power supply device 200 can also be connected to the bushing 202 of the emergency power supply device 200 (and also further said devices can be connected thereto), since the bushing allocation corresponds to the plug allocation of the plug 201 a of the connection cable 201. Of course, other devices can also be connected thereto, which are connected to the motor controller.

The housing 210 can be a profile pipe which is cut to length, for example, wherein the transverse wall 217 is implemented as a plug. The profile tube has in its interior the compartment 213 and auxiliary groups, into which circuit boards are insertable, for example, on which the electrical/electronic components are applied, mounted, and wired.

### LIST OF REFERENCE SIGNS

1 piece of furniture
2 base element
3 support element
4 back part
5 leg part
6 movement fitting
7, 8 adjustment drive
7a, 8a drive line
9 control unit
9a supply unit
9b network cable
9c network plug
9d control block
9e control switch
9f control terminal
10, 10′operating unit
11 housing
12, 13 operating element
14 signal element
15, 16, 17 auxiliary operating element
18 operating line
19 output element
100 electromotive furniture drive
200 emergency power supply device
201 connection cable
201a plug
202 bushing
210 housing
211 fastening section
212 actuating tab
213 compartment
214 floor wall
215, 216 longitudinal side wall
217 transverse wall
217a opening
218 cover wall
218a, 218b surface
218c connection surface
219 recess
219a opening
220 energy store
220a terminal clip
221 charging unit
222, 223 signal light
230 nightlight
231 movement detector
240, 241, 242 operating element
243 keyboard
244 keyboard element
250 USB terminal
260 Bluetooth unit
M mattress

1.-16. (canceled)

17. An emergency power supply device for an electromotive furniture drive of a piece of furniture, said emergency power supply device comprising:
a housing configured in the form of an envelope housing having fastening sections and an internal compartment;
at least one energy store arranged in the internal compartment of the housing;
a connection cable having at least two power lines and at least one auxiliary line for connection to the electromotive furniture drive; and
at least one operating element arranged in the internal compartment of the housing.

18. The emergency power supply device of claim 17, wherein the housing is a profile which is cut to length and has one transverse side which is closed by a transverse wall like a plug.

19. The emergency power supply device of claim 17, further comprising at least one nightlight arranged in the housing.

20. The emergency power supply device of claim 19, further comprising a movement detector or proximity switch configured to control the at least one nightlight.

21. The emergency power supply device of claim 17, further comprising a charging unit for the at least one energy store.

22. The emergency power supply device of claim 17, further comprising a further operating element, which is implemented as an electrical button for training operating units having control of a wireless transmission link (radio/infrared/ultrasound).

23. The emergency power supply device of claim 17, further comprising a further operating element as an auxiliary button, which is implemented as an electrical button for activating synchronization of devices to be associated.

24. The emergency power supply device of claim 17, further comprising a keyboard having keyboard elements, which are provided as operating elements for moving adjustment drives of the electromotive furniture drive.

25. The emergency power supply device of claim 17, further comprising a USB terminal.

26. The emergency power supply device of claim 17, further comprising at least one storage unit for storing drive-related data.

27. The emergency power supply device of claim 17, further comprising a Bluetooth unit.

28. The emergency power supply device of claim 27, wherein the Bluetooth unit is a Bluetooth converter and/or a WLAN converter, and is provided for activating the electromotive furniture drive and/or for a wireless data exchange.

29. The emergency power supply device of claim 17, wherein the auxiliary line of the connection cable is a control line and signal line, data line, and/or auxiliary energy line.

30. An electromotive furniture drive for adjusting a movable part of a piece of furniture, said electromotive furniture drive comprising:
an output element;
at least one adjustment drive having at least one electric motor, a speed-reducing gear coupled to the at least one electric motor and coupled in driving relationship to the output element to linearly displace and/or rotate the output element;
at least one control unit;
at least one operating unit operatively connected to the at least one control device to operate the at least one adjusting drive; and
an emergency power supply device including a housing configured in the form of an envelope housing having fastening sections and an internal compartment, at least one energy store arranged in the internal compartment of the housing, a connection cable having at least two power lines and at least one auxiliary line for connection to the electromotive furniture drive, and at least one operating element arranged in the internal compartment of the housing.

31. A piece of furniture, comprising:
at least one base element configured to couple the piece of furniture to a set up location, and
at least one support element having at least one part which is arranged movably in relation to the support element or in relation to a further support element or in relation to the base element, said at least one movably arranged part being constructed to be displaceable and/or pivotable; and
at least one electromechanical furniture drive coupled to the at least one movably arranged part and comprising an output element, at least one adjustment drive having at least one electric motor, a speed-reducing gear coupled to the at least one electric motor and coupled in driving relationship to the output element to linearly displace and/or rotate the output element, at least one control unit, at least one operating unit operatively connected to the at least one control device to operate the at least one adjusting drive, and an emergency power supply device including a housing configured in the form of an envelope housing having fastening sections and an internal compartment, at least one energy store arranged in the internal compartment of the housing, a connection cable having at least two power lines and at least one auxiliary line for connection to the electromotive furniture drive, and at least one operating element arranged in the internal compartment of the housing.

32. The piece of furniture of claim 31, wherein the control unit has a charging circuit for the at least one energy store of the emergency power supply device.
